(19) United States
(12) Patent Application Publication
(10) Pub. No.: US 2015/0039316 A1
(43) Pub. Date: Feb. 5, 2015

(54) SYSTEMS AND METHODS FOR MANAGING DIALOG CONTEXT IN SPEECH SYSTEMS

(71) Applicant: GM Global Technology Operations LLC, Detroit, MI (US)

(72) Inventors: ELI TZIRKEL-HANCOCK, RA'ANANA (IL); ROBERT D. SIMS, III, MILFORD, MI (US); OMER TSIMHONI, RAMAT HASHARON (IL)

(73) Assignee: GM Global Technology Operations LLC, Detroit, MI (US)

(21) Appl. No.: 13/955,579

(22) Filed: Jul. 31, 2013

(51) Int. Cl. G10L 15/18; G10L 15/22; G06F 3/16

(52) U.S. Cl. CPC G10L 15/1815; G06F 3/167; G10L 15/22
USPC 704/275

(57) ABSTRACT

Methods and systems are provided for managing spoken dialog within a speech system. The method includes establishing a spoken dialog session having a first dialog context, and receiving a context trigger associated with an action performed by a user. In response to the context trigger, the system changes to a second dialog context. In response to a context completion condition, the system then returns to the first dialog context.

### TECHNICAL FIELD

The technical field generally relates to speech systems, and more particularly relates to methods and systems for managing dialog context within a speech system.

### BACKGROUND

Vehicle spoken dialog systems or “speech systems” perform, among other things, speech recognition based on speech uttered by occupants of the vehicle. The speech utterances typically include commands that communicate with or control one or more features of the vehicle as well as other systems that are accessible by the vehicle. A speech system generates spoken commands in response to the speech utterances, and in some instances, the spoken commands are generated in response to the speech recognition needing further information in order to perform the speech recognition.

In many instances, the user may wish to change the spoken dialog topic before the session has completed. That is, the user might wish to change “dialog context” during a session. This might occur, for example, when: (1) the user needs further information in order to complete a task, (2) the user cannot complete a task, (3) the user has changed his or her mind, (4) the speech system took a wrong path in the spoken dialog, or (5) the user was interrupted. In currently known systems, such scenarios often result in dialog failure and user frustration. For example, the user might quit the first spoken dialog session, begin a new spoken dialog session to determine missing information, and then begin yet another spoken dialog session to complete the task originally meant for the first session.

Accordingly, it is desirable to provide improved methods and systems for managing dialog context in speech systems. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for managing spoken dialog within a speech system. The method includes establishing a spoken dialog session having a first dialog context, and receiving a context trigger associated with an action performed by the user. In response to the context trigger, the system changes to a second dialog context. Subsequently, in response to a context completion condition, the system then returns to the first dialog context.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a speech system in accordance with various exemplary embodiments;

FIG. 2 is a conceptual block diagram illustrating portions of a speech system in accordance with various exemplary embodiments;

FIG. 3 illustrates a dialog context state diagram in accordance with various exemplary embodiments; and

FIG. 4 illustrates a dialog context method in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

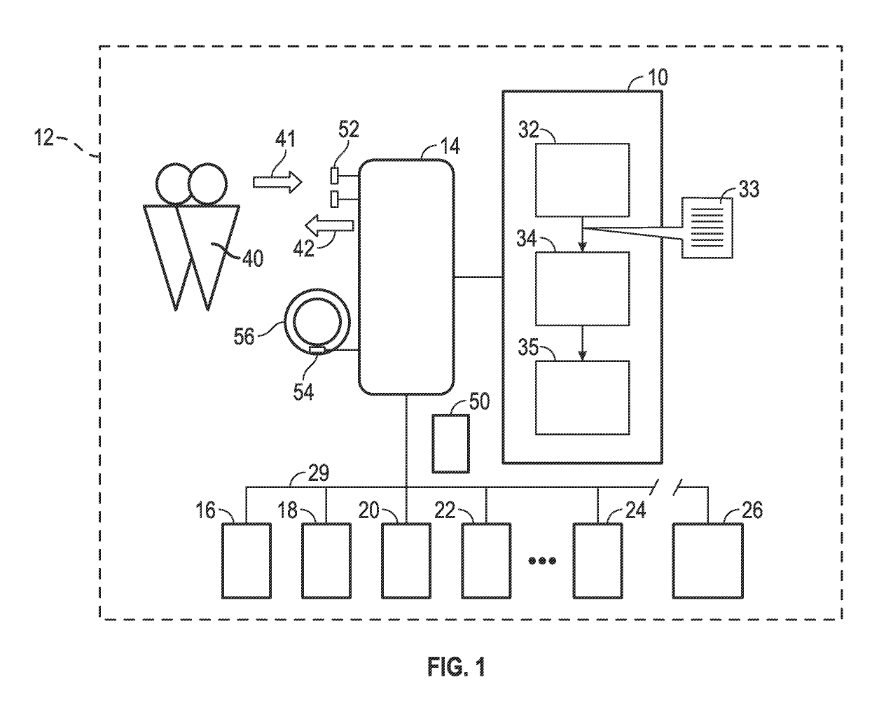

Referring now to FIG. 1, in accordance with exemplary embodiments of the subject matter described herein, a spoken dialog system (or simply “speech system”) 10 is provided within a vehicle 12. In general, speech system 10 provides speech recognition, dialog management, and speech generation for one or more vehicle systems through a human machine interface module (HMI) module 14 configured to be operated by (or otherwise interface with) one or more users 40 (e.g., a driver, passenger, etc.). Such vehicle systems may include, for example, a phone system 16, a navigation system 18, a media system 20, a telematics system 22, a network system 24, and any other vehicle system that may include a speech dependent application. In some embodiments, one or more of the vehicle systems are communicatively coupled to a network (e.g., a proprietary network, a 4G network, or the like) providing data communication with one or more back-end servers 26.

One or more mobile devices 50 might also be present within vehicle 12, including various smart-phones, tablet computers, feature phones, etc. Mobile device 50 may also be communicatively coupled to HMI 14 through a suitable wireless connection (e.g., Bluetooth or WiFi) such that one or more applications resident on mobile device 50 are accessible to user 40 via HMI 14. Thus, a user 40 will typically have access to applications running on at three different platforms: applications executed within the vehicle systems themselves, applications deployed on mobile device 50, and applications residing on back-end server 26. It will be appreciated that speech system 10 may be used in connection with both vehicle-based and non-vehicle-based systems having speech dependent applications, and the vehicle-based examples provided herein are set forth without loss of generality.

Speech system 10 communicates with the vehicle systems 14, 16, 18, 20, 22, 24, and 26 through a communication bus and/or other data communication network 29 (e.g., wired, short range wireless, or long range wireless). The communication bus may be, for example, a controller area network (CAN) bus, local interconnect network (LIN) bus, or the like.

As illustrated, speech system 10 includes a speech understanding module 32, a dialog manager module 34, and a speech generation module 35. These functional modules may be implemented as separate systems or as a combined, integrated system. In general, HMI module 14 receives an acoustic signal (or “speech utterance”) 41 from user 40, which is provided to speech understanding module 32.

Speech understanding module 32 includes any combination of hardware and/or software configured to processes the speech utterance from HMI module 14 (received via one or more microphones 52) using suitable speech recognition techniques, including, for example, automatic speech recognition and semantic decoding (or spoken language understanding (SLU)). Using such techniques, speech understanding module 32 generates a result list (or simply “list”) 33 of possible results from the speech utterance. In one embodiment, list 33 comprises one or more sentence hypothesis representing a probability distribution over the set of utterances that might have been spoken by user 40 (i.e., utterance 41). List 33 might, for example, take the form of an N-best list. In various embodiments, speech understanding module 32 generates list 33 using predefined possibilities stored in a datastore. For example, the predefined possibilities might be names or numbers stored in a phone book, names or addresses stored in an address book, song names, albums or artists stored in a music directory, etc. In one embodiment, speech understanding module 32 employs front-end feature extraction followed by a Hidden Markov Model (HMM) and scoring mechanism.

Dialog manager module 34 includes any combination of hardware and/or software configured to manage an interaction sequence and a selection of speech prompts 42 to be spoken to the user based on list 33. When a list contains more than one possible result, or a low confidence result, dialog manager module 34 uses disambiguation strategies to manage an interaction with the user such that a recognized result can be determined. In accordance with exemplary embodiments, dialog manager module 34 is capable of managing dialog contexts, as described in further detail below.

Speech generation module 35 includes any combination of hardware and/or software configured to generate spoken prompts 42 to a user 40 based on the dialog act determined by the dialog manager 34. In this regard, speech generation module 35 will generally provide natural language generation (NLG) and speech synthesis, or text-to-speech (TTS).

List 33 includes one or more elements that represent a possible result. In various embodiments, each element of the list includes one or more “slots” that are each associated with a slot type depending on the application. For example, if the application supports making phone calls to phonebook contacts (e.g., “Call John Doe”), then each element may include slots with slot types of a first name, a middle name, and/or a last name. In another example, if the application supports navigation (e.g., “Go to 1111 Sunshine Boulevard”), then each element may include slots with slot types of a house number, and a street name, etc. In various embodiments, the slots and the slot types may be stored in a datastore and accessed by any of the illustrated systems. Each element or slot of the list 33 is associated with a confidence score.

In addition to spoken dialog, users 40 might also interact with HMI 14 through various buttons, switches, touch-screen user interface elements, gestures (e.g., hand gestures recognized by one or more cameras provided within vehicle 12), and the like. In one embodiment, a button 54 (e.g., a “push-to-talk” button or simply “talk button”) is provided within easy reach of one or more users 40. For example, button 54 may be embedded within a steering wheel 56.

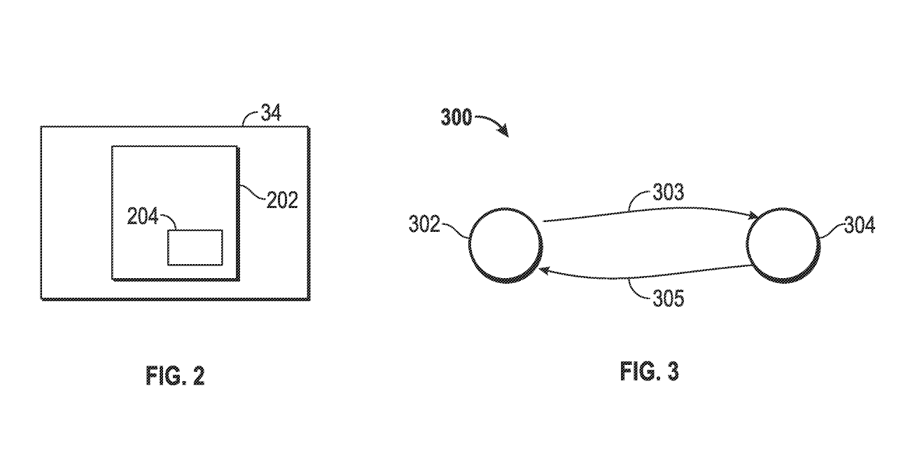

Referring now to FIG. 2, in accordance with various exemplary embodiments dialog manager module 34 includes a context handler module 202. In general, context handler module 202 includes any combination of hardware and/or software configured to manage and understand how users 40 switch between different dialog contexts during a spoken dialog session. In one embodiment, for example, context handler module 202 includes a context stack 204 configured to store information (e.g., slot information) associated with one or more dialog contexts, as described in further detail below.

As used herein, the term “dialog context” generally refers to a particular task that a user 40 is attempting to accomplish via spoken dialog, which may or may not be associated with a particular vehicle system (e.g., phone system 16 or navigation system 18 in FIG. 1). In this regard, dialog contexts may be visualized as having a tree or hierarchy structure, where the top node corresponds to the overall spoken dialog session itself, and the nodes directly below that node comprise the general categories of tasks provided by the speech system—e.g., “phone”, “navigation”, “media”, “climate control”, “weather,” and the like. Under each of those nodes fall more particular tasks associated with that system. For example, under the “navigation” node one might find, among others, a “changing navigation settings” node, a “view map” node, and a “destination” node. Under the “destination” node, the context tree might include a “point of interest” node, an “enter address node”, and so on. The depth and size of such a context tree will vary depending upon the particular application, but will generally include nodes at the bottom of the tree that are referred to as “leaf” nodes (i.e., nodes with no further nodes below them). For example, the manual entering of a specific address into the navigation system (and the assignment of the associated information slots) may be considered a leaf node in some embodiments. In general, then, the various embodiments described herein provided a way for a user to move within the context tree provided by the speech system, and in particular allow the user to easily move between the dialog contexts associated with the leaf nodes themselves.

Referring now to FIG. 3 (in conjunction with both FIGS. 1 and 2), a state diagram 300 may be employed to illustrate the manner in which dialog contexts are managed by context handler module 202 based on user interaction. In particular, state 302 represents a first dialog context, and state 304 represents a second dialog context. Transition 303 from state 302 to state 304 takes place in response to a “context trigger,” and transition 305 from state 304 to state 302 takes place in response to a “context completion condition.” While FIG. 3 illustrates two dialog contexts, it will be appreciated that one or more additional or “nested” dialog context states might be traversed during a particular spoken dialog session. Note that the transitions illustrated in this figure take place within a single spoken dialog session, rather than in a sequence of multiple spoken dialog sessions (as when a user quits a session then enters another session to determine unknown information, which is then used in a subsequent session.)

A wide variety of context triggers may be used in connection with transition 303. In one example, the context trigger is designed to allow the user to easily and intuitively switch between dialog contexts without being subject to significant distraction. In one exemplary embodiment, the activation of a button (e.g., “talk button” 54 of FIG. 1) is used as the context trigger. That is, when the user wishes to change contexts, the user simply presses the “talk” button and continues the speech dialog, now within a second dialog context. In some variations, the button is a virtual button—i.e., a user interface component provided on a central touch screen display.

In an alternate embodiment, the context trigger is a preselected word or phrase spoken by the user—e.g., the phrase “switch context.” The preselected phrase may be user-configurable, or may be preset by the context handler module. As a variation, a particular sound (e.g., a clicking noise or whistling sound made by the user) may be used as the context trigger.

In accordance with one embodiment, the context trigger is produced in response to a natural language interpretation of the user's speech suggesting that the user wishes to change context. For example, during a navigation session, the user may simply speak the phrase “I would like to call Jim now, please” or the like.

In accordance with another embodiment, the context trigger is produced in response to a gesture made by a user within the vehicle. For example, one or more cameras communicatively coupled to a computer vision module (e.g., within HMI 14) are capable of recognizing a hand wave, finger motion, or the like as a valid context trigger.

In accordance with one embodiment, the context trigger corresponds to speech system 10 recognizing that a different user has begun to speak. That is, the driver of the vehicle might initiate a spoken dialog session that takes place within a first dialog context (e.g., the driver changing a satellite radio station). Subsequently, when a passenger in the vehicle interrupts and speaks a request to perform a navigation task, the second dialog context (navigation to an address) is entered. Speech system 10 may be configured to recognize individual users using a variety of techniques, including voice analysis, directional analysis (e.g., location of the spoken voice), or another other convenient method.

In accordance with another embodiment, the context trigger corresponds to the speech system 10 determining that the user has begun to speak in a different direction (e.g., toward a different microphone 52). That is, for example, the user might enter a first dialog context by speaking at a microphone in the rear-view mirror, and then change dialog context by speaking a microphone embedded in the central console.

The context completion condition used for transition 305 (i.e., for returning to the original state 302) may also constitute a variety of actions. In one embodiment, for example, the context completion condition corresponds to the particular sub-task being complete (e.g., completion of a phone call). In another embodiment, the act of successfully filling in the required “slots” of information can itself constitute the context completion condition. Stated another way, since the user will often switch dialog contexts for the purposes of filling in missing information not acquired in the first context, the system may automatically switch back to the first context once the required information is received. In other embodiments, the user may explicitly indicate the desire to return to the first context using, for example, any of the methods described above in connection with transition 303.

The following presents one example in which a user changes context to determine missing information, which the user then uses to complete the task:

1. <User> “Send message to John.”
2. <System> “OK. Dictate a message for John.”
3. <User> “Hi, John. I'm on my way, and I'll be there
. . .”
4. <User> [activates context trigger]
5. <User> “What is my ETA?”
6. <System> “Your estimated time of arrival is four
p.m.”
7. <User> “. . . around four p.m.”

As can be seen in this example, the first dialog context (composing a voice message) is interrupted by the user at step 4 in order to determine the estimated time during a second dialog context (a navigation completion estimate). After the system provides the estimated time of arrival, the system automatically returns to the first dialog context. The previous dictation has been preserved notwithstanding the dialog context switch, and thus the user can simply continue with the dictated message starting from where he left off.

The following presents another example, in which information the user corrects for an incorrect dialog path taken by the system.

1. <User> “Play John Lennon.”
2. <System> “OK. Setting destination to John Lennon
Avenue. Please enter number”
3. <User> “Hold on. I want to listen to music.”
4. <System> “OK. Which album or title?”

In the above example, at step 2 the system has misinterpreted the user's speech and has entered a navigation dialog context. The user then uses a predetermined phrase “hold on” as a context switch, causing the system to enter a media dialog context. Alternatively, the system may have interpreted the phrase “Hold on. I want to listen to music” via natural language analysis to infer the user's intent.

The following example is also illustrative of a case where the user changes from a navigation dialog context to a phone call context to determine missing information.

1. <User> “Find me a restaurant serving seafood.”
2. <System> “Bill's Crab Shack is a half mile away and
serves seafood.”
3. <User> “What is their price range?”
4. <System> “Sorry. No price range information
available.”
5. <User> [activates context trigger]
6. <User> “Call Bob.”
7. <System> “Calling Bob.”
8. <Bob> “Hello?”
9. <User> “Hey, Bob. Is Bill's Crab Shack expensive?”
10. <Bob> “Um, no. It's a 'crab shack'.”
11. <User> “Thanks. Bye.” [hangs up]
12. <User> “OK. Please take me there.”
13. <System> “Loading destination...”

In other embodiments, the missing information from the second dialog context is automatically transferred back to the first dialog context upon returning.

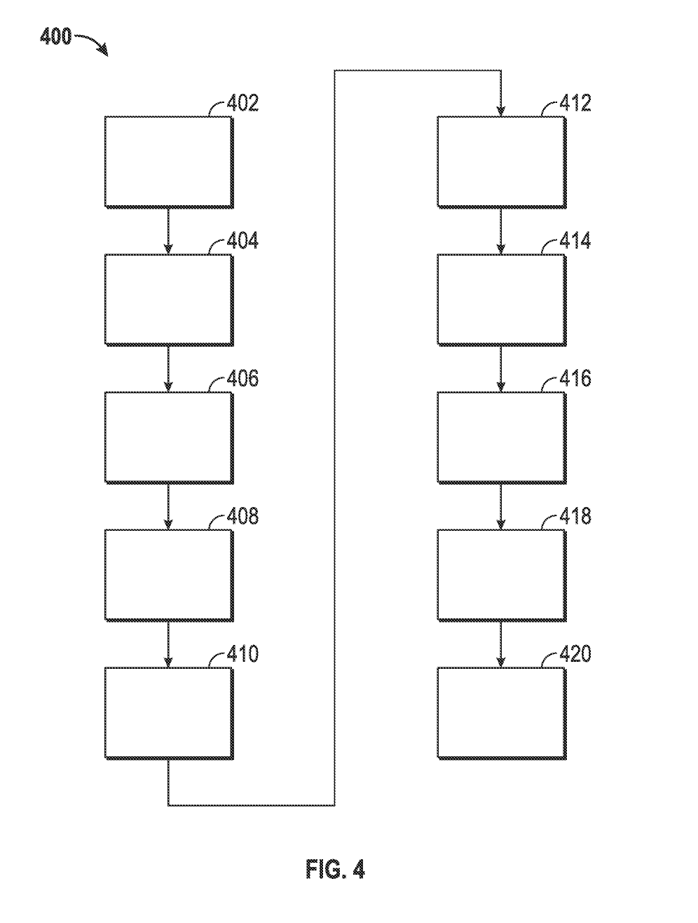

Referring now to the flowchart illustrated in FIG. 4 in conjunction with FIGS. 1-3, an exemplary context-switching method 400 will now be described. It should be noted that the illustrated method is not limited to the sequence shown in FIG. 4, but may be performed in one or more varying orders as applicable. Furthermore, one or more steps of the illustrated method may be added or removed in various embodiments.

Initially, it is assumed that a spoken dialog session has been established and is proceeding in accordance with a first dialog context. During this session, the user activates the appropriate context trigger (402), such as one of the context triggers described above. In response, the context management module 202 pushes onto context stack 204 the current context (404) and the return address (406). That is, context stack 204 comprises a first in, last out (FILO) stack that stores information regarding one or more dialog contexts. A “push” places an item on the stack, and a “pop” removes an item from the stack. The pushed information will typically include data (e.g., “slot information”) associated with the task being performed in that particular context. Those skilled in the art will recognize that context stack 204 may be implemented in a variety of ways. In one embodiment, for example, each dialog state is implemented as a class and is a node in a dialog tree as described above. The phrases “class” and “object” are used herein consistent with their use in connection with common object-oriented programming languages, such as Java or C++. The return address then corresponds to a pointer to the context instantiation. The present disclosure is not so limited, however, and may be implemented using a variety of programming languages.

Next, in 408, context handler module 202 switches to the address corresponding to the second context. Upon entering the second context, a determination is made as to whether the system has entered this context as part of a “switch” from another context (410). If so, the spoken dialog continues until the context completion condition has occurred (412), whereupon the results of the second context are themselves pushed onto context stack 204 (414). Next, the system recovers the (previously pushed) return address from context stack 204 and returns to the first dialog context (416). Next, within the first dialog context, the results (from the second dialog context) are read from context stack 204 (418). The original dialog context, which was pushed onto context stack 204 during 404, is then retrieved and incorporated into the first dialog context (420). In this way, dialog contexts can be switched mid-session, rather than requiring the user to terminate a first session, start a new session to determine missing information (or the like), and then begin yet another session to complete the task originally intended for the first session. Stated another way, one set of data determined during the second dialog context is optionally incorporated into another set of data determined during the first dialog context in order to accomplish a session task.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method for managing spoken dialog within a speech system, the method comprising:
establishing a spoken dialog session having a first dialog context;
receiving a context trigger associated with an action performed by a user;
in response to the context trigger, changing to a second dialog context; and
in response to a context completion condition, returning to the first dialog context.

2. The method of claim 1, wherein the action performed by the user corresponds to a button press.

3. The method of claim 2, wherein the button press corresponds to the pressing of a button incorporated into a steering wheel of an automobile.

4. The method of claim 1, wherein the action performed by the user corresponds to at least one of: speaking a preselected phrase, performing a gesture, and speaking in a predetermined direction.

5. The method of claim 1, wherein data determined during the second dialog context is incorporated into data determined during the first dialog context in order to accomplish a session task.

6. The method of claim 5, further comprising pushing the second set of data on a context stack prior to changing to the second dialog context.

7. A speech system comprising:
a speech understanding module configured to receive a speech utterance from a user and produce a result list associated with the speech utterance;
a dialog manager module communicatively coupled to the speech understanding module, the dialog manager module including a context handler module configured to: receive the result list; establish, with the user, a spoken dialog session having a first dialog context based on the result list; receive a context trigger associated with an action performed by a user; in response to the context trigger, change to a second dialog context; and in response to a context completion condition, return to the first dialog context.

8. The speech system of claim 7, wherein the context trigger comprises a button press.

9. The speech system of claim 8, wherein the button press corresponds to the pressing of a button incorporated into a steering wheel of an automobile.

10. The speech system of claim 7, wherein the context trigger comprises a preselected phrase spoken by the user.

11. The speech system of claim 7, wherein the context trigger comprises a gesture performed by the user.

12. The speech system of claim 7, wherein the context trigger comprises a determination that the user is speaking in a predetermined direction.

13. The speech system of claim 7, wherein the context trigger comprises a determination that a second user has begun to speak.

14. The speech system of claim 7, wherein data determined during the second dialog context is incorporated into data determined during the first dialog context in order to accomplish a session task.

15. The speech system of claim 14, wherein the context handler module includes a context stack and is configured to push the second set of data on the context stack prior to changing to the second dialog context.

16. The speech system of claim 7, wherein the context completion condition comprises the completion of a sub-task performed by the user.

17. Non-transitory computer-readable media bearing software instructions, the software instructions configured to instruct a speech system to:
establish, with a user, a spoken dialog session having a first dialog context;
receive a context trigger associated with an action performed by a user;
in response to the context trigger, change to a second dialog context; and
in response to a context completion condition, return to the first dialog context

18. The non-transitory computer-readable media of claim 17, context trigger corresponds to the pressing of a button incorporated into a steering wheel of an automobile.

19. The non-transitory computer-readable media of claim 17, wherein data determined during the second dialog context is incorporated into data determined during the first dialog context in order to accomplish a session task.

20. The non-transitory computer-readable media of claim 19, wherein the software instructions instruct the processor to push the second set of data onto a context stack prior to changing to the second dialog context
